(19) United States
(12) Patent Application Publication
(10) Pub. No.: US 2019/0246213 A1
(43) Pub. Date: Aug. 8, 2019

(54) PIEZOELECTRIC SPEAKER UNIT TO BE INSTALLED IN MOBILE TERMINAL

(71) Applicant: WISOL CO., LTD., Gyeonggi-do (KR)

(72) Inventors: Soo Chan LIM, Gyeonggi-do (KR); Jung Rae NOH, Gyeonggi-do (KR); Yo Sep CHOI, Gyeonggi-do (KR)

(21) Appl. No.: 16/260,727

(22) Filed: Jan. 29, 2019

(30) Foreign Application Priority Data
Feb. 2, 2018 (KR) 10-2018-0013512

(51) Int. Cl. H04R 17/00; H04R 1/02

(52) U.S. Cl. CPC H04R 17/00; H04R 2499/11; H04R 1/025

(57) ABSTRACT

Provided is a piezoelectric speaker unit to be installed in a mobile terminal. The piezoelectric speaker unit includes a plate, a piezoelectric body attached to a central part of the plate, and an edge type support member which supports one surface of the plate along an edge thereof and provides a space therein in which the plate is deformable. Here, at least one opening, which has one side communicating with the space and the other side communicating with the outside of the support member to release sounds generated in the space by oscillation of the plate to the outside of the support member, is formed in the support member.

### CROSS-REFERENCE TO RELATED APPLICATION

This application claims priority to and the benefit of Korean Patent Application No. 10-2018-0013512, filed on Feb. 2, 2018, the disclosure of which is incorporated herein by reference in its entirety.

### FIELD

The present invention relates to a piezoelectric speaker, and more particularly, to a piezoelectric speaker unit to be installed in a mobile terminal.

### BACKGROUND

Generally, a speaker is an audio device which converts an electrical signal into oscillation of a diaphragm, generates longitudinal waves in the air, and copies sound waves. For playing music or for voice, dynamic speakers having relatively high performance are generally used. Dynamic speakers use a principle in which when a voice signal current is applied to a coil in a magnetic field of a permanent magnet, a mechanical force is applied to the coil according to the intensity of the current and initiates a movement. Such dynamic speakers need a space for mounting a coil and a permanent magnet therein, and particularly, a space which is adequate in a thickness direction.

However, recently, as mobile terminals such as a smart phone, a tablet personal computer (PC), a laptop PC, and the like has been miniaturized and has become thinner, speakers, which occupy less space are necessary to be installed in such mobile terminals, are necessary. To this end, as an alternative to the dynamic speakers, piezoelectric speakers capable of being embodied with a smaller thickness have appeared.

Piezoelectric speakers use a principle in which when an electrical signal is applied to a piezoelectric body attached to a thin plate, in connection therewith, the piezoelectric body elongates or contracts and the plate performs vertical curvature movement so as to generate sounds. Since such piezoelectric speaker do not need a coil and a permanent magnet, it is possible to embody smaller and thinner speakers.

However, since piezoelectric speakers do not perform well in a low-frequency band thereof and show an excessive sound pressure property in a high-frequency band, it is impossible to provide well-balanced sound quality characteristics overall in a range thereof. Accordingly, piezoelectric speakers have not been generally applied yet to mobile terminal which require sound qualities at or above a certain level.

### SUMMARY

The present invention is directed to providing a piezoelectric speaker unit to be installed in a mobile terminal, which has more improved sound quality characteristics.

One aspect of the present invention provides a piezoelectric speaker unit to be mounted on a mobile terminal, the piezoelectric speaker unit including a plate, a piezoelectric body attached to a central part of the plate, and an edge type support member which supports one surface of the plate along an edge thereof and provides a space therein in which the plate is deformable. Here, at least one opening, which has one side communicating with the space and the other side communicating with the outside of the support member to release sounds generated in the space by oscillation of the plate to the outside of the support member, is formed in the support member.

The opening may be formed to communicate with at least one speaker hole formed in a side surface of a housing of the mobile terminal.

A plurality of such speaker holes may be formed, and the opening may be integrally formed to communicate with the plurality of speaker holes.

A plurality of such speaker holes may be formed, and a plurality of such openings may be formed to communicate with the plurality of speaker holes.

The opening may have a groove shape which is opened upward or downward from the support member.

The opening may have a hole shape which passes through a side surface of the support member.

The piezoelectric speaker unit may further include an edge type adhesive layer formed along the edge of the one surface of the plate between the support member and the plate.

Another aspect of the present invention provides a housing of a mobile terminal on which a piezoelectric speaker unit is mounted. Here, the housing has an inner bottom surface and an inner side surface in which at least one speaker hole is formed. The piezoelectric speaker unit includes a plate, a piezoelectric body attached to a central part of the plate, and an edge type support member which supports one surface of the plate along an edge thereof and provides a space therein in which the plate is deformable. Also, at least one opening, which has one side communicating with the space and the other side communicating with the at least one speaker hole formed in the side surface of the housing of the mobile terminal to release sounds generated in the space by oscillation of the plate through the speak hole, is formed in the support member.

A side surface of the support member, in which the opening is formed, may come into contact with the inner side surface of the housing, in which the speaker hole is formed.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates a state in which a piezoelectric speaker unit installed in a mobile terminal according to embodiments of the present invention;

FIG. 2 is an exploded perspective view of a piezoelectric speaker unit according to a first embodiment of the present invention;

FIG. 3 is a cross-sectional view of the piezoelectric speaker unit according to the first embodiment of the present disclosure;

FIG. 4 is an exploded perspective view of a piezoelectric speaker unit according to a second embodiment of the present invention;

FIG. 5 is a cross-sectional view of the piezoelectric speaker unit according to the second embodiment of the present disclosure;

FIG. 6 illustrates a shape of openings formed in a support member according to another embodiment modified from the first embodiment of the present invention;

FIG. 7 illustrates a shape of openings formed in a support member according to another embodiment modified from the second embodiment of the present invention;

FIG. 8A illustrates a state in which a sound is generated upward from a plate in a general piezoelectric speaker unit, and FIG. 8B illustrates a state in which a sound is discharged toward a side surface of a support member through an opening formed in the support member according to embodiments of the present invention; and

FIG. 9 is a graph illustrating comparison between frequency characteristics of collected sounds in cases of FIGS. 8A and 8B.

### DETAILED DESCRIPTION

Hereinafter, exemplary embodiments of the present invention will be described in detail with reference to the attached drawings. In the following description and the attached drawings, substantially like elements are referred to as like reference numerals and a repetitive description will be omitted. In the description of the present invention, a detailed description on well-known functions or components of the related art will be omitted when it is deemed to obscure the essence of the present invention.

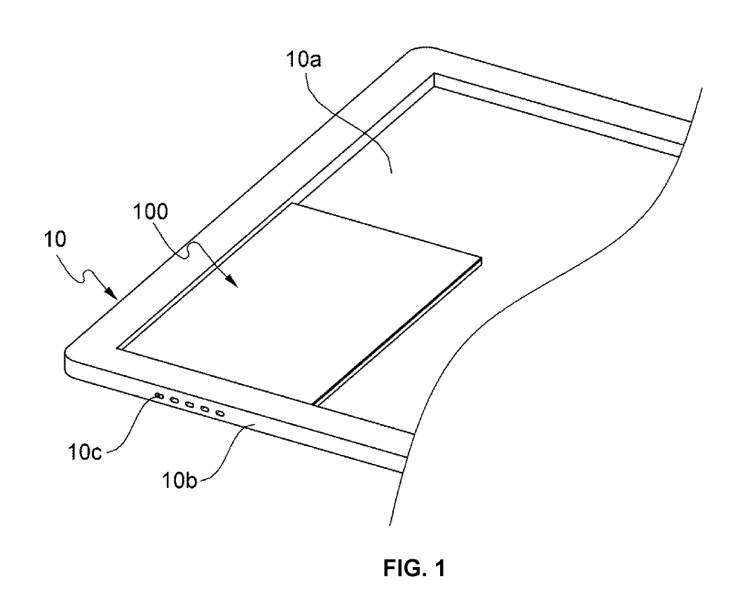

FIG. 1 illustrates a state in which a piezoelectric speaker unit 100 installed in a mobile terminal according to embodiments of the present invention.

The mobile terminal includes all portable terminals on which a speaker is mountable, for example, a smart phone, a tablet personal computer (PC), a laptop PC, a portable multimedia player (PMP), and the like.

A housing 10 of the mobile terminal has an internal space in which a variety of components such as a piezoelectric speaker unit 100, a circuit board (not shown), and the like are mounted, and a bottom surface 10a thereinside and includes one or more speaker holes 10c in a side surface 10b of the housing 10. A top of the housing 10 may be covered by a cover, a display panel, a glass panel, or the like.

The piezoelectric speaker unit 100 is mounted such that one side surface thereof comes into contact with an inner surface of the housing 10 where the speaker holes 10c are formed. According to the embodiment of the present invention, a sound generated upward from the piezoelectric speaker unit 100 is suppressed from being released outward from the housing 10 by the cover, the display panel, the glass panel, or the like which covers the housing 10. On the other hand, the sound is released from the side surface of the piezoelectric speaker unit 100 so as to be released through the speaker holes 10c of the housing 10.

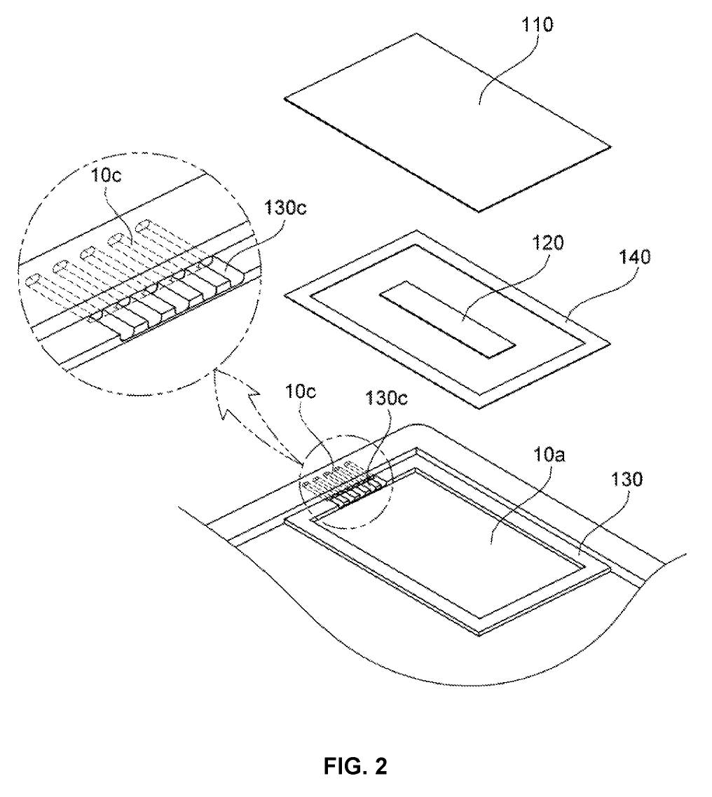

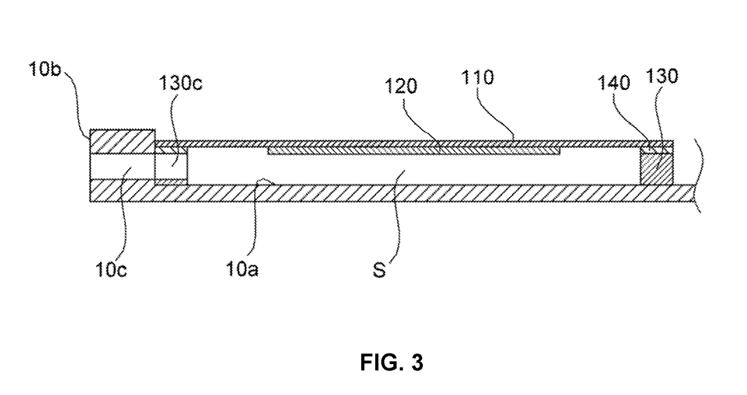

FIGS. 2 and 3 are views of a piezoelectric speaker unit according to a first embodiment of the present invention. FIG. 2 is an exploded perspective view, and FIG. 3 is a cross-sectional view.

The piezoelectric speaker unit according to the embodiment includes a plate 110, a piezoelectric body 120 attached to a central part of one surface of the plate 110, a support member 130 attached to the bottom surface 10a of the housing 10 and supporting the plate 110, and an adhesive layer 140 between the plate 110 and the support member 130.

The plate 110 generally has a quadrangular shape and may include a metal material or a polymer material. In the case of the metal material, for example, stainless steel and the like may be included. In the case of the polymer material, for example, polyethylene naphthalate (PEN), thermoplastic polyurethane (TPU), polyethylene terephthalate (PET), and the like may be included. In the case of the plate 110 of a polymer material, an edge-shaped frame may be attached to each of a top and a bottom of the plate 110 along an edge thereof.

The piezoelectric body 120 may be manufactured using a material having an excellent piezoelectric property such as quartz, tourmaline, Rochelle salt, barium titanate, monoammonium phosphate, tartaric acid ethylenediamine, and the like. The piezoelectric body 120 may be attached to the plate 110 using an adhesive (not shown).

The support member 130 supports the plate 110 along an edge of one surface of the plate 110 and has a quadrangular edge shape along the edge of the one surface of the plate 110 to provide a space S therein in which the plate 110 is deformable. When an electrical signal is applied to the piezoelectric body 120, the piezoelectric body 120 elongates or contracts in connection with the electrical signal such that the plate 110 vertically oscillates and sounds are generated.

The adhesive layer 140 performs a function of allowing the support member 130 to adhere to the plate 110 and has a quadrangular edge shape along the edge of the one surface of the plate 110 like the support member 130.

The plate 110 performs vertical curvature movement such that sounds are generated upward and downward from the plate 110. In the case of a general speaker structure, in order to release the sounds generated upward from the plate 110, a speaker hole may be formed in a part of a cover (not shown) of the housing 10 above the plate 110 or a speaker hole may be formed in a part of the side surface 10b of the housing 10 corresponding to a top of the plate 110.

However, according to the embodiment of the present invention, sounds generated upward from the plate 110 are suppressed from being released outward from the housing 10 using the cover, the display panel, or the which covers the housing 10, and at least one opening 130c is formed in some of four side surfaces of the support member 130 which come into contact with the inner surface of the housing 10 to release sounds generated in the space S below the plate 110 outward from the support member 130. Here, the opening 130c is formed to communicate with the speaker hole 10c formed in the side surface 10b of the housing 10 such that sounds generated in the space S below the plate 110 are released outward from the housing 10 through the opening 130c and the speaker hole 10c.

According to the first embodiment of the present invention, as shown in FIG. 2, a plurality of such openings 130c may be formed to communicate with a plurality of such speaker holes 10c and may have a groove shape opened upward from the support member 130. On the other hand, the openings 130c may have a groove shape opened downward from the support member 130.

An upper surface of the support member 130 may be flush with or formed above an upper surface of the speaker hole 10c, and one side surface of the plate 110 is disposed to come into contact with the inner surface of the housing 10 in which the speaker holes 10c are formed such that a space above the plate 10 may be spatially isolated from the speaker holes 10c. Then, sounds generated upward from the plate 110 are suppressed from being released outward from the housing 10 through the speaker holes 10c.

In the case of sounds generated upward from the plate 110, performance in a low-frequency band thereof is relatively deteriorated like a general piezoelectric speaker and an excessive sound pressure property is shown in a high-frequency band thereof such that balanced sound quality characteristics of overall bandwidths are not provided.

However, sounds generated downward from the plate 110 is restricted in the chamber type space S surrounded by the bottom surface 10a of the housing 10, the support member 130, and the plate 110 such that sound qualities are modified such as being reinforced in a low-frequency band and being suppressed a high-frequency band due to a resonance phenomenon. Accordingly, sounds having modified sound qualities as described above are released through the opening 130c of the support member 130 and the speaker holes 10c of the housing 10. That is, the sounds, which are improved in chronic problems of piezoelectric speakers having deteriorated performance in a low-frequency band and an excessive sound pressure property in a high-frequency band, are released.

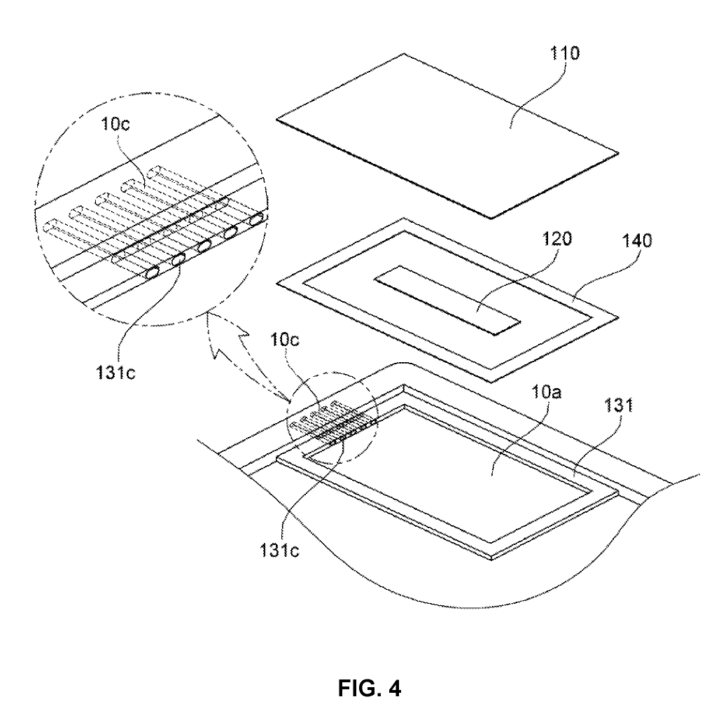

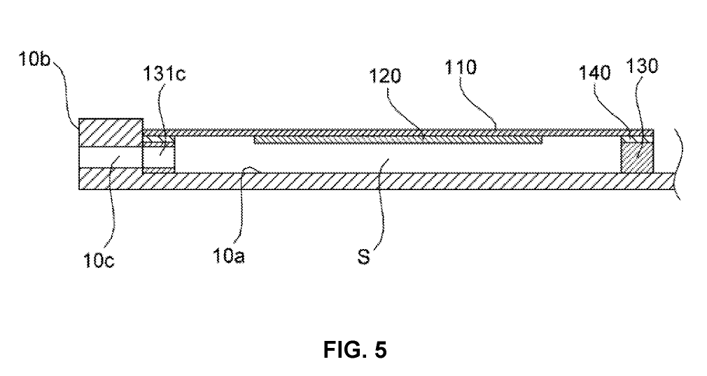

FIGS. 4 and 5 are views of a piezoelectric speaker unit according to a second embodiment of the present invention. FIG. 4 is an exploded perspective view, and FIG. 5 is a cross-sectional view. Hereinafter, since the second embodiment is mainly equal to the first embodiment, only differences from the first embodiment will be described.

Although the openings 130c formed in the support member 130 have a groove shape opened upward from the support member 130 in the first embodiment, in the second embodiment, openings 130c of a support member 131 may have a hole shape passing through a side surface of the support member 131.

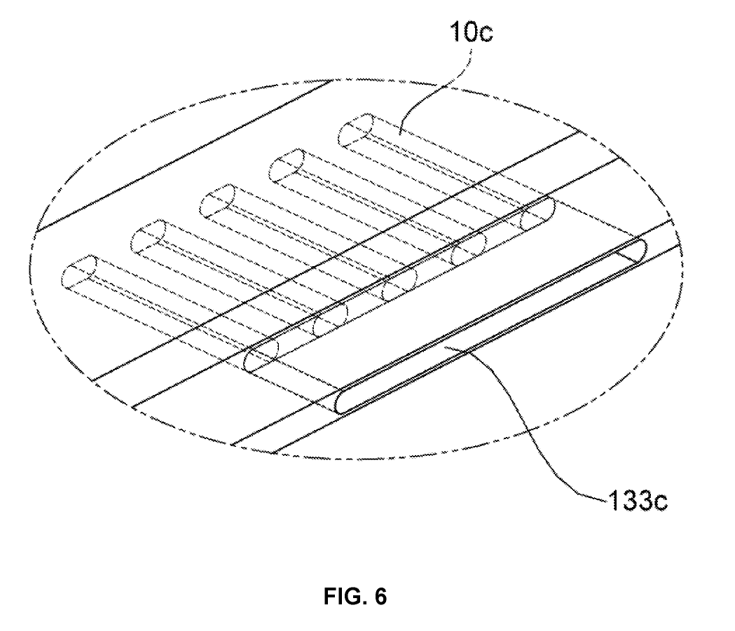

FIG. 6 illustrates a shape of openings 132c formed in a support member according to another embodiment modified from the first embodiment of the present invention.

Although the plurality of openings 130c formed in the support member 130 have a groove shape to communicate with the plurality of speaker holes 10c in the first embodiment, the openings 132c may have an integrally formed groove shape to communicate with the plurality of speaker holes 10c at the same time as shown in the drawing.

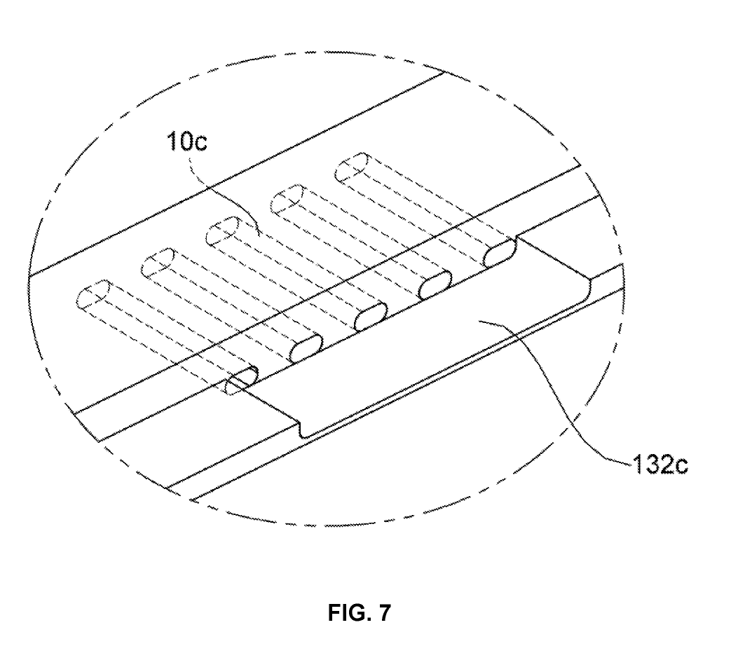

FIG. 7 illustrates a shape of openings 133c formed in a support member according to another embodiment modified from the second embodiment of the present invention.

Although the plurality of openings 130c formed in the support member 130 have a shape of a plurality of holes passing through the side surface of the support member 131 to communicate with the plurality of speaker holes 10c in the first embodiment, the openings 133c may have a shape of integrally formed holes passing through the side surface of the support member to communicate with the plurality of speaker holes 10c at the same time as shown in the drawing.

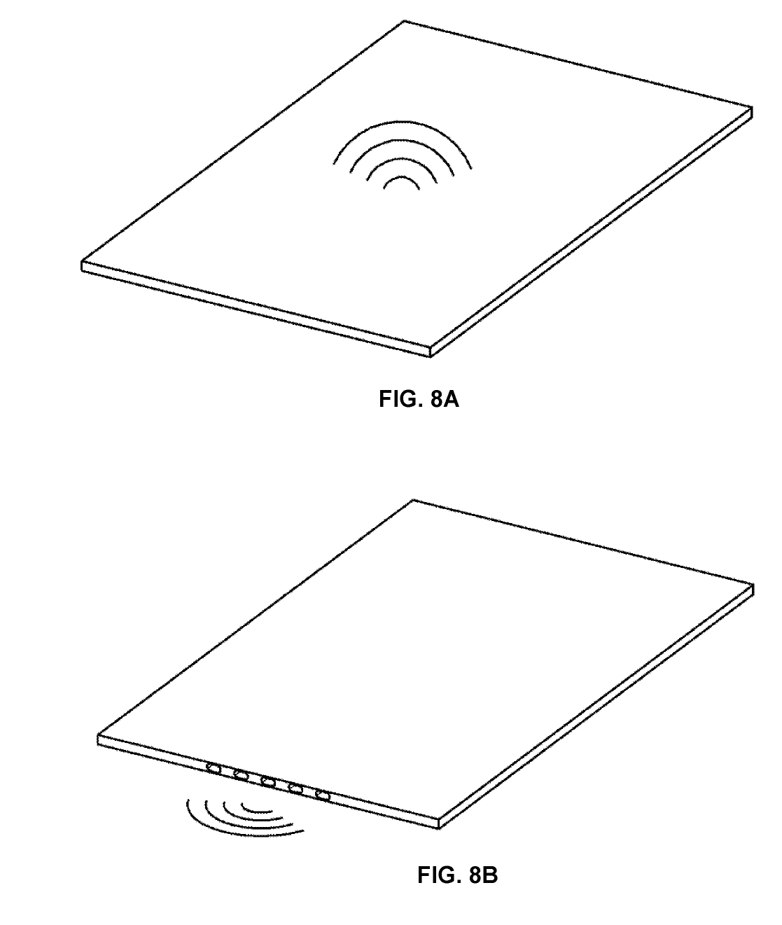

FIG. 8A illustrates a state in which a sound is generated upward from a plate in a general piezoelectric speaker unit, and FIG. 8B illustrates a state in which a sound is discharged toward a side surface of a support member through an opening formed in the support member according to embodiments of the present invention.

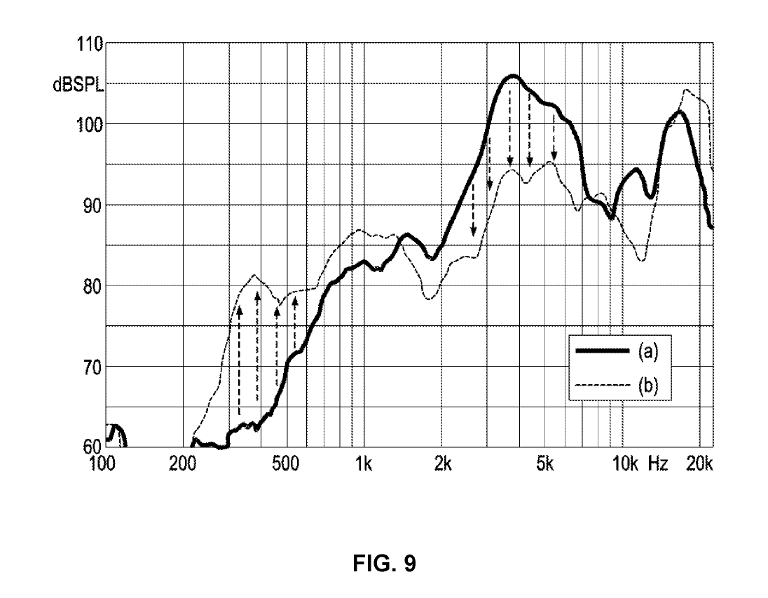

FIG. 9 is a graph illustrating comparison between frequency characteristics of collected sounds in cases of FIGS. 8A and 8B. Referring to FIG. 9, an x-axis refers to a frequency, and for example, 20 k refers to 2 mega hertz (MHz). A y-axis indicates a level of a sound pressure, and dBSPL is used as a unit thereof.

Referring to FIG. 9, In the case of (b), in comparison to (a), it may be seen that sound pressures are reinforced in a low-frequency band and suppressed in a high-frequency band. That is, sounds released toward the side surface of the support member through the openings formed in the support member, are reinforced in a low-frequency band and are suppressed in a high-frequency band so as to have better-balanced sound quality characteristics in a range thereof.

According to the embodiments of the present invention, a support member supporting a plate, to which a piezoelectric body is attached, along an edge thereof and providing a space, in which the plate is deformable, therein includes at least one opening, which has one side communicating with the space and the other side communicating with the outside of the support member so as to release sounds, which are generated in the space by oscillation of the plate, to the outside of the support member through the opening. The released sounds are reinforced in a low-frequency band thereof and suppressed in a high-frequency band thereof in comparison to sounds generated upward from the plate such that it is possible to provide well-balanced sound quality characteristics in a range thereof.

The exemplary embodiments of the present invention have been described above. It can be understood by one of ordinary skill in the art that modifications may be made without departing from the essential features of the present invention. Therefore, the disclosed embodiments should be considered in a descriptive point of view not in a limitative one. The scope of the present invention is defined by the claims not by the above description, and it should be understood that all differences within the equivalent scope thereof are included in the present invention.

What is claimed is:

1. A piezoelectric speaker unit to be installed in a mobile terminal, the piezoelectric speaker unit comprising:
a plate;
a piezoelectric body attached to a central part of the plate; and
an edge type support member which supports one surface of the plate along an edge thereof and provides a space therein in which the plate is deformable,
wherein at least one opening, which has one side communicating with the space and the other side communicating with the outside of the support member to release sounds generated in the space by oscillation of the plate to the outside of the support member, is formed in the support member.

2. The piezoelectric speaker unit of claim 1, wherein the opening is formed to communicate with at least one speaker hole formed in a side surface of a housing of the mobile terminal.

3. The piezoelectric speaker unit of claim 2, wherein a plurality of such speaker holes are formed, and
wherein the opening is integrally formed to communicate with the plurality of speaker holes.

4. The piezoelectric speaker unit of claim 2, wherein a plurality of such speaker holes are formed, and
wherein a plurality of such openings are formed to communicate with the plurality of speaker holes.

5. The piezoelectric speaker unit of claim 1, wherein the opening has a groove shape which is opened upward or downward from the support member.

6. The piezoelectric speaker unit of claim 1, wherein the opening has a hole shape which passes through a side surface of the support member.

7. The piezoelectric speaker unit of claim 1, further comprising an edge type adhesive layer formed along the edge of the one surface of the plate between the support member and the plate.

8. A housing of a mobile terminal on which a piezoelectric speaker unit is mounted, wherein the housing has an inner bottom surface and an inner side surface in which at least one speaker hole is formed,
wherein the piezoelectric speaker unit comprises:
a plate;
a piezoelectric body attached to a central part of the plate; and
an edge type support member which supports one surface of the plate along an edge thereof and provides a space therein in which the plate is deformable, and
wherein at least one opening, which has one side communicating with the space and the other side communicating with the at least one speaker hole formed in the side surface of the housing of the mobile terminal to release sounds generated in the space by oscillation of the plate through the speak hole, is formed in the support member.

9. The housing of claim 8, wherein a side surface of the support member, in which the opening is formed, comes into contact with the inner side surface of the housing, in which the speaker hole is formed.
